(19) United States
(12) Patent Application Publication
(10) Pub. No.: US 2013/0207473 A1
(43) Pub. Date: Aug. 15, 2013

(54) Method, system and apparatus for redirecting use of any inverter or uninterruptable power supply with improved solar power management

(71) Applicant: Babu Jain, Cupertino, CA (US)

(72) Inventor: Babu Jain, Cupertino, CA (US)

(21) Appl. No.: 13/815,134

(22) Filed: Feb. 2, 2013

Related U.S. Application Data
(60) Provisional application No. 61/595,075, filed on Feb. 4, 2012.

(51) Int. Cl. H02J 9/06

(52) U.S. Cl. CPC H02J 9/06
USPC 307/65

(57) ABSTRACT

Method, apparatus and system for converting or redirecting use of any inverter or uninterruptable power supply (UPS) with the help of the proposed Solar Management Unit (SMU) into a standalone or off-grid solar system of equivalent capacity solar power. The SMU simplifies the system design to utilize existing investment in an inverter and other equipment and reduces solar system installation time.

### PRIORITY CLAIM

This patent application claims the benefit of the U.S. provisional patent application having Ser. No. 61/595,075, filed Feb. 4, 2012; the aforementioned application being incorporated by reference in its entirety.

### FIELD OF THE DISCLOSURE

Embodiments disclosed herein relate to a system, apparatus and method of converting or redirecting use of any inverter based backup power supply or uninterruptable power supply with the help of the described herein solar management unit (SMU) into a standalone (i.e., off-grid), grid tied or grid tied bidirectional solar system powered by solar power.

### BACKGROUND

A simple inverter based back up power supply system uses an inverter with a battery to supply AC power when mains (or grid) power is not available. An inverter is an electrical power device that converts direct current (DC) to alternating current (AC). Inverters are used in a wide range of applications and commonly used to supply AC power from DC sources such as batteries. Such a system 100 is shown in FIG. 1A and includes battery 102 and inverter 104. Adding a solar source to this system would allow for renewable backup power. A solar power system 120 as illustrated in FIG. 1B shows the addition of a solar source to a battery backup system and includes the following major components: solar panel(s) or module 122, charge controller 124, battery 126, and inverter 128. A driven load may receive AC power from the solar array 122 or the battery 126 in case of failure of the main power supply. While this system 120 is greener than the system of FIG. 1A, it still does not optimally produce power from a solar source.

### SUMMARY OF THE INVENTION

In an aspect of the disclosure herein: a method of integrating a solar panel into a backup power supply system comprising: connecting a solar management unit (SMU) to a pre-existing backup power system including a battery, inverter and AC mains power; connecting at least one solar panel to the SMU; performing an initialization process wherein the SMU detects the capacity of the battery, inverter and solar panel; and determining which of the AC mains power or solar panel will charge the battery.

In another aspect of the disclosure herein: A solar management unit (SMU) comprising: a processor with a memory; a plurality of terminals located on the SMU allowing the SMU to be able to receive and provide output to an inverter and at least one battery; a solar charge controller configured to receive input from a solar panel and in communication with the processor; a first controlled switching element in is communication with the processor and directed by the processor to turn on or off AC mains power availability; and a second controlled switching element also under control of the processor and in connection with the solar charge controller to turn on or off battery charge output.

In another aspect of the disclosure herein: a solar management unit (SMU) comprising: a processor with a memory, wherein the processor is configured to receive capacity condition measurements of a plurality of elements connected to said SMU; a plurality of terminals located on the SMU allowing the SMU to be able to receive and provide outputs to the plurality of elements including an inverter and at least one battery; a solar charge controller including an MPPT configured to receive input from a solar panel and in communication with the processor; a first controlled switching element in communication with the processor and directed by the processor to turn on or off AC mains power availability; a second controlled switching element also under control of the processor and in connection with the solar charge controller to turn on or off battery charge output; and wherein the processor is further configured to prioritize directing that power be provided to a load based on a predetermined sequence.

### BRIEF DESCRIPTION OF THE DRAWINGS

FIGS. 1A and 1B illustrate prior art UPS and solar power systems.

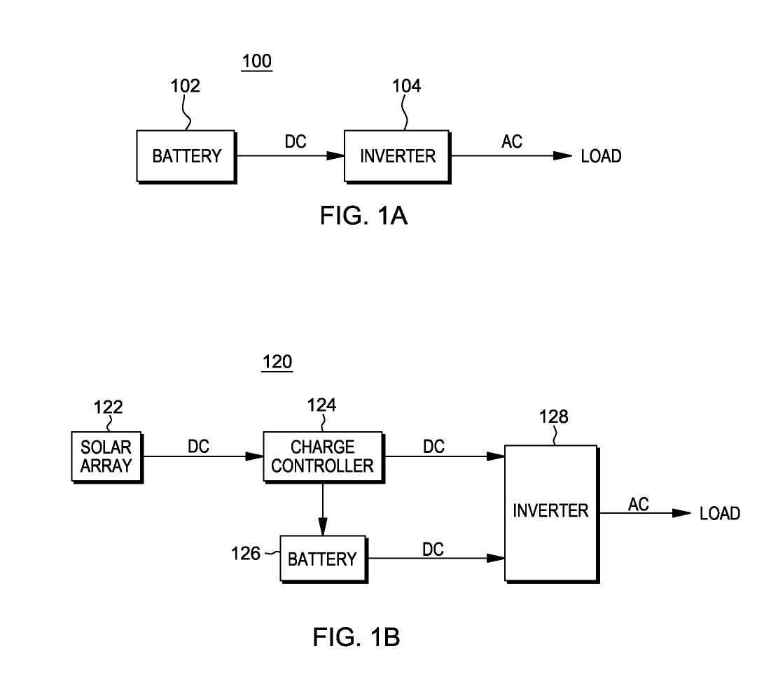

FIG. 2A illustrates a control system for controlling an output of a solar panel in accordance with a first embodiment.

FIG. 2B illustrates a control system for controlling an output of a solar panel in accordance with a second embodiment.

FIG. 3 represents an overview block diagram of the SMU 202 which can be used for both the system as disclosed in FIG. 2A and FIG. 2B.

FIG. 4 shows the internal design of the SMU used when the system of FIG. 2A is implemented.

FIG. 5 is a detailed illustration showing the internal design of the SMU when the system of FIG. 2B is implemented.

FIG. 6 represents an alternative overview block diagram of the SMU 202.

FIG. 7 illustrates a method of operation of a typical system utilizing the SMU of this detailed description.

### DETAILED DESCRIPTION OF EMBODIMENTS

The embodiments described herein relate to a system, apparatus and method of converting or redirecting use of any inverter based backup power supply system or uninterruptable power supply (UPS) system with the help of a described solar management unit (SMU) into a standalone (i.e., off-grid), grid tied or grid tied bidirectional solar system powered by solar power. There is a significant installed base in the market of inverters as well as UPS systems for backup using a diesel generator or battery storage as a second source. One disadvantage of diesel generators is that they lead to polluting of the environment. The SMU described herein allows for an inexpensive way to convert an inverter based backup supply systems or UPS systems to work as a solar power system while using an existing inverter and battery (or batteries).

One of the issues when using solar power as a source is the temperature levels at the solar panels. A solar panel's operating point (voltage and current) may be determined by an electronic circuit called a maximum power point tracker (“MPPT”). As the temperature increases, the MPPT drifts to produce a lower energy output. The V_{oc}, or open circuit voltage, reduces significantly and I_{sc}, or short circuit current, increases marginally. As a result, the battery behavior in the solar source system is also impacted by the operating temperature. Currently, MPPT based solar systems do not provide for temperature compensation. Thus, when solar panel temperature increases and the V_{oc} drops, and the panel works at new maximum power point voltage (V_{MPP}) and maximum power point current (I_{MPP}) values. A solar system circuit including an SMU as described herein will compensate for the change in the temperature and provide correction for reducing solar panel stress.

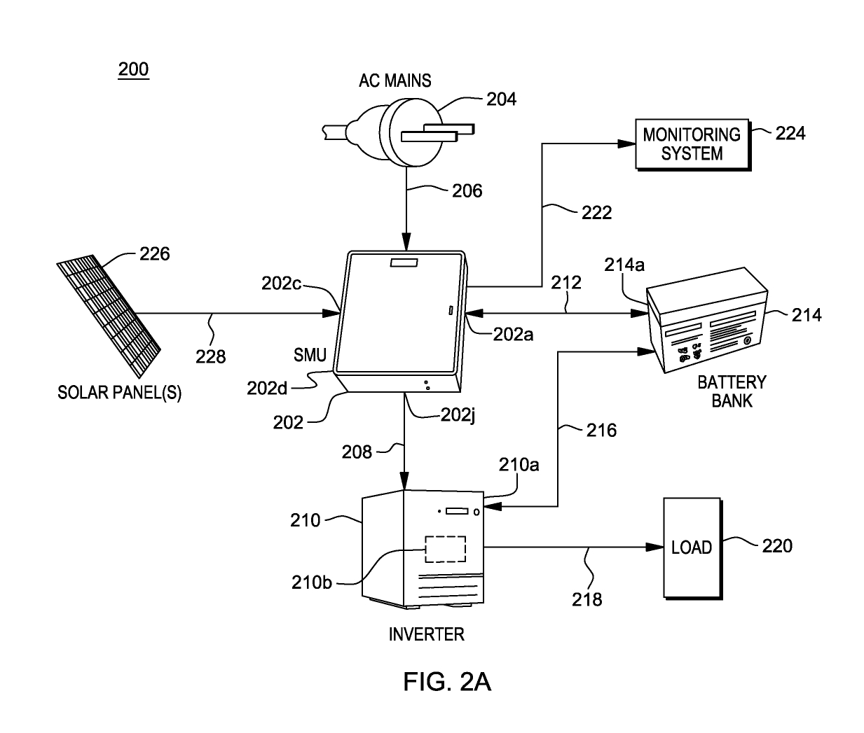

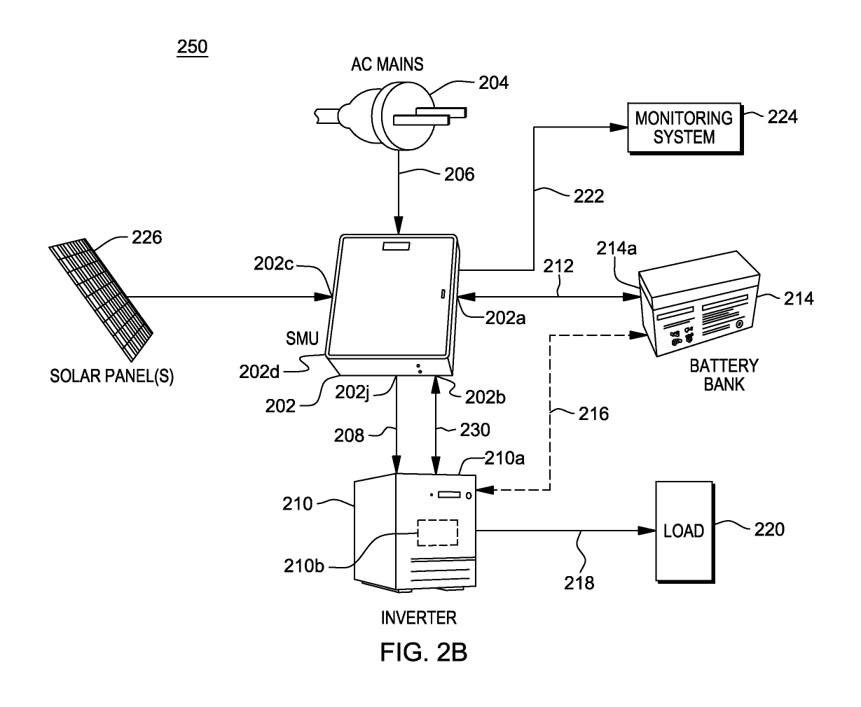

For example, in a first embodiment shown in FIG. 2A shows what was originally just a UPS system with an inverter connected to a battery and to AC mains power converted to a solar power system with the addition of a solar panel 226 and an SMU 202. In operation of this solar power system 200, the load is normally connected to mains power and solar power is used to charge the batteries. When mains power fails, the system switches so that the load is driven by a battery (or batteries) through the inverter. There are a plurality of internal SMU configurations which may be used in accordance with the preferred embodiments described herein that are differentiated by architectures, internal circuits, power ratings and priorities of various power sources. The configuration of the SMU 202 can also be based on various internal solar charge controllers such as a MPPT, MPPT with maximum current point tracking (MPCT), pulse width modulation (PWM), or other types of charge controllers. As discussed above, an MPPT charge controller is designed to maximize harvest and storage of harvested power with very high conversion efficiencies of over 99% but does not properly account for temperature changes. The addition of an MPCT charge controller to an MPPT ensures that the highest possible current is transferred to the battery. Examples of such charge controllers are discussed in detail in commonly owned U.S. patent applications Ser. No. 12/643,266, filed on Jun. 24, 2010, and Ser. No. 13/095,766, filed on Oct. 27, 2011, which are both hereby incorporated by reference in their entirety.

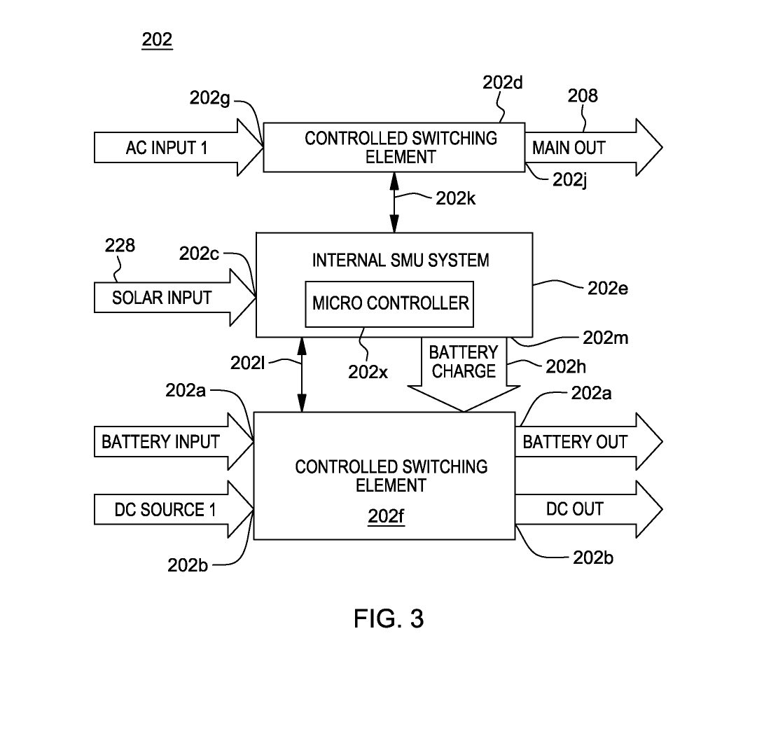

In the solar power source system of FIG. 2A, the SMU 202 is connected to mains electricity 204 which is a general purpose AC electric power supply (also known as “AC mains” or the grid). The SMU 202 is designed to accept any type of power supply input from AC mains 204 as long it does not exceed predetermined voltages and currents. AC mains 204 power is routed through AC line 206 to a terminal on SMU 202. AC mains power may then be connected or disconnected from the load 220 via a controlled switching element and relay (referenced as 202d in FIGS. 3 to 6) located in the SMU 202 through AC line 208 to an inverter 210. The SMU 202 may be designed to connect to any type of inverter 210 which accepts the standard power supply in the country of use. The system 200 can operate with an on the grid or off the grid inverter 210.

The battery terminals 202a of the SMU 202 may be connected via DC line 212 to the battery terminals 214a of a battery 214 (or, alternatively, a bank of a plurality of batteries). The original DC connection 216 in place before the addition of the SMU 202 and the solar array 226 to the system between the inverter 210 and the battery 214 may remain unchanged. Therefore, the AC mains power may be used to charge the battery 214 from mains power (as discussed below) through line 216 and the battery 214 can provide power to the load 220 through the inverter 210. The solar panel (or, alternatively, a string of solar panels) 226 is connected via DC line 228 to the photo-n voltaic inputs 202c of the SMU 202. Control and switching circuitry in the SMU 202 (as discussed in detail below) is used to relay the solar power from the panel 226 to charge the battery 214 through DC line 212. An advantage of the present embodiment is that the SMU 202 can be connected to crystalline or thin film panels based on any technology. Also, the SMU 202 can also be connected to other power sources besides (or in place of) the solar panels 226 such as a diesel generator or a wind turbine (not shown).

The SMU 202 described herein may include various functionalities and features driven by hardware and internal software programs which may be configured depending on the end application. Such control circuitry hardware may include an internal processor coupled to a memory, an integrated circuit or a microcontroller (as shown by reference numeral 202x) or any combination thereof. A decision tree for prioritization of energy storage as well as energy use can be programmed into a microcontroller 202x to implement priority options. There are at least 4 priority options or sequences that may be programmed into the control circuitry of the SMU 202 which sequence the use of solar, battery and grid for optimal power production. In one embodiment, a prioritization sequence to drive the load 220 may be starting with high priority to low priority:

a. Solar→Battery→Grid

b. Solar→Grid→Battery

c. Grid→Solar→Battery

d. Grid→Battery→Solar

The SMU 202 allows for use of all possible decision sequences for charging and discharging the battery 214 and for driving load 220 priorities. Factoring into the decision on the priority options may be whether the environment switch is set as urban or rural. Also, in an alternative embodiment, sensors (not shown) may be connected to the SMU 202 that can determine the weather such as temperature and sunshine to help determine which priority option should be chosen. Also, weather criteria may be input either from the monitoring system 224 or some other control system which is remotely located. Environment mode switch (or button) 202d allows the SMU 202 to operate efficiently in both urban and rural environments. When the environment mode is set to urban mode, the SMU 202 is ideal for a city location where AC mains power dependency is very high. When the environment mode is set to rural mode, the SMU 202 is better suited for locations where interruption in AC mains power is quite common. In an alternative embodiment, instead of a switch (or button) 202d the environment mode may be changed through the monitoring system 224 which allows the mode to be controlled remotely.

In a typical operation, the SMU 202 will charge the battery 214 from the solar panels 226 as a top priority though it can be directed to charge other power sources also. When the battery voltage of the battery 214 drops below a specified level which is programmed into the microcontroller 202x of the SMU 202, the battery 214 may also be charged from AC mains 204 using a mains charger 210b located in the inverter 210 through line 216. When battery charge level reaches a predetermined or preprogrammed level in a microcontroller 202x, the AC mains 204 charging will be cut off. The load 220 will be primarily driven by the inverter 210 through AC line 218 using power stored in the battery 214 or solar power from the solar panel 226 if it is available. Another option is to drive the load 220 directly by power from AC mains 204. In this case the battery 214 will be charged by solar energy and on predetermined conditions programmed in the microcontroller 202x, the battery 214 will start charging using power from AC mains 204. An advantage of the embodiments disclosed in this detailed description is that the SMU 202 can be connected to any battery or storage element which can store electrical energy and can transfer electrical energy to the load when in demand by the load controlled by any type of charge control system (i.e., MPPT, PWM, etc.).

The system 200 also may include a monitoring system 224 which can be connected through a communication line 222 to direct operation of the SMU 202. Alternatively, the monitoring system 224 can be monitored from a remote location (“remote monitoring system”). This could be subscription based Software as a Service (SAAS) implemented in a dedicated portal to manage and monitor the system 200 or a plurality of systems. For this, the remote monitoring system may be equipped with a general packet radio service (GPRS) cellular communication device (e.g., a Solcom GPRS module) to collect and transmit the data remotely.

Upon being added to a new system, the SMU 202 will perform initial characterization or testing of the system. When the SMU 202 is installed and turned on, during setup the SMU 202 is programmed to identify battery 214 capacity, inverter 210 capacity and solar power capacity from the solar panel 226. The SMU 202 will also start to collect data on the load pattern from the load 220 and will do so on a continuous basis. The data will be analyzed by the microcontroller 202x within the SMU 202 and will be used to optimize the source of power used to drive the load 220 and charge the battery 214. The SMU 202 is further configured to track battery 214 status and make decisions based on an internal software program in the microcontroller 202x. AC mains 204 will start charging the battery 214 when the battery voltage will drop below a minimum battery charge level referred as V_{bmin} and AC mains 204 charging will stop charging the battery 214 when maximum battery charge level referred as Vbmax is reached. SMU 210 will detect V_{bmin} and V_{bmax} of the inverter 210. The SMU 202 will use these parameters to set up new AC main 204 charging on and off conditions. The microcontroller 202x will also make decisions such as: whether the load 220 should be driven by solar or battery power; whether the power source for charging the battery 214 should come from solar or mains power supply; when AC mains 204 power supply should start charging batteries 214; when AC mains 204 power supply should stop charging the battery 214; when AC mains 204 power supply should start driving the load 220; and when AC mains 204 supply should stop driving load 220. Also, the SMU 202 is further designed to measure power generation from solar panel 226; measure power used from AC mains 204 power supply; and send indications or results to a display or communication interface on the monitoring system 224.

In another system setup as illustrated in FIG. 2B, system 250 is altered so that the load 220 is driven by solar power from the solar panel 226 directly through DC line 230 and when solar power is not present or the load 220 is higher than the solar power that is available, the SMU 202 will direct the system 250 to switch to battery 214. Battery 214 will provide power through DC line 212 to the SMU 202 and through DC line 230 to the inverter 210 and then through AC line 218 to the load 220. Battery 214 charging is turned on or off depending on the status of the battery 214 and a program stored in the microcontroller 202x of the SMU 202. The battery 214 may either be charged from the solar array 226 or from AC mains power which travels through SMU 202 to the inverter 210, is then converted to DC power and travels through DC line 230 back through the SMU 202 and on to the battery 214. The SMU 202 architecture is such that the connection 216 running from the battery terminals 210a of the inverter 210 may be disconnected from the battery 214 and reconnected as the connection 230 to the terminals 202b of the SMU 202. As a result the controlled battery terminal 202a is provided as output of the SMU 202 which will then connect to the battery 214 input terminals 214a.

The interface of the SMU 202 is designed so that the inverters, batteries and connection diagrams are simple so as to make it easy to install the SMU 202 and make appropriate wiring changes as required to complete the system installation. As previously discussed, the SMU 202 is specifically designed to be versatile and capable of converting all types of inverters or UPS systems into solar power systems.

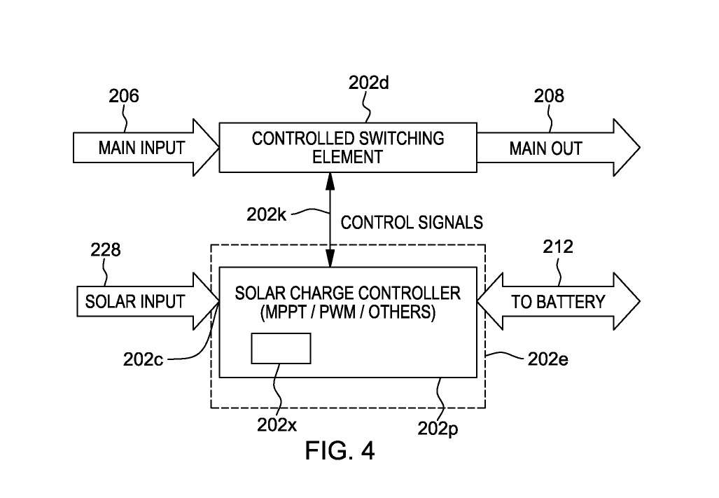

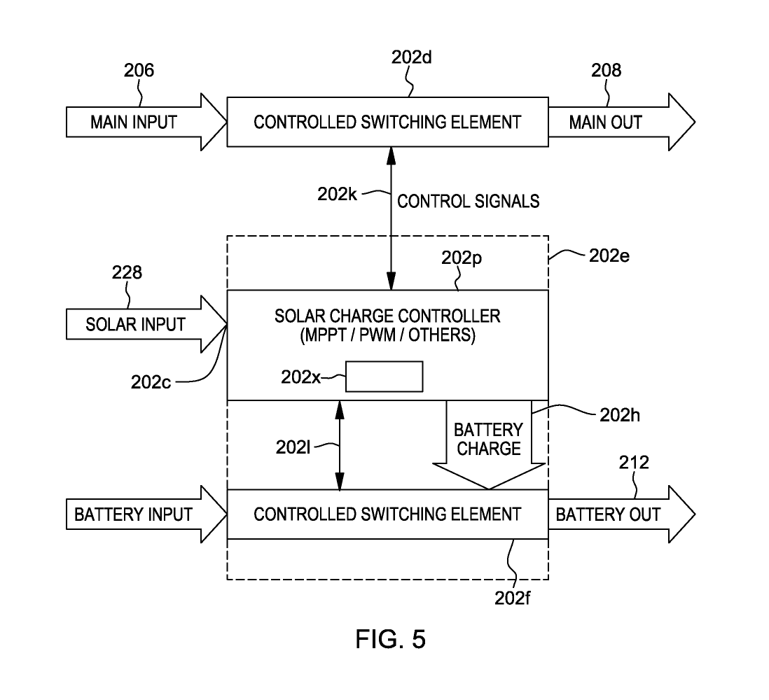

FIG. 3 represents an overview block diagram of the SMU 202 which can be inserted into both the system disclosed in FIG. 2A and the system disclosed in FIG. 2B. SMU 202 includes a controlled switching element (or relay) module 202d, an internal SMU system module 202e and priority logic and switching elements module 202f. SMU 202 further includes a microcontroller 202x communicatively coupled to each of the controlled switching element module 202d, SMU system module 202e and priority logic and switching elements module 202f. An AC input including AC input terminal 1 202g provides power from AC mains 204 to SMU 202. The microcontroller 202x is programmed to direct controlled switching element 202d through communication line 202k to connect the AC power to AC main out terminal 202j to either 1) send AC power to the inverter 210 when the load 220 is operating off AC main power or 2) charge the battery 214. The microcontroller 202x may turn power from AC mains 204 on or off. SMU system module 202e is comprised of a solar charge controller such as MPPT, PWM (or other types of controllers) and controlling circuitry (e.g., microcontroller 202x). Detailed architecture and operation of internal SMU system module 202e will be further discussed in connection with FIGS. 4 and 5. Internal SMU system module 202e is capable of receiving power input from the solar panels 226 through terminal 202c. Internal SMU system module 202e will connect the solar power through terminal 202m to the priority logic and switching elements module 202f.

The microcontroller 202x is further programmed to direct priority logic and switching elements 202f through communication line 2021. The priority logic and switching elements module 202f is configured to provide the battery charge 202h from solar panel 226 through terminal 202a to charge the battery 214. In the case of FIG. 2B, when power is required by the load 220 from battery 214, the power is passed through connection 212 to terminal 202a (as shown in FIGS. 2A and 3) connected by priority logic and switching element module 202f to terminal 202b and then through line 230 to the inverter 210 and then to the load 220. Also, in the case of FIG. 2B, when the battery 214 needs to be charged by AC mains power, power is routed from AC mains 204 through SMU 202 and inverter 210 and back to the SMU 202 as DC power to be received at terminal 202b. Therefore, the SMU 202 allows the load 220 to be driven by battery power (converted to AC power using the inverter 210) or solar power controlled by solar charge controller or AC mains power directly.

Details of the plurality of internal connections and method of operation of the SMU 202 are disclosed in FIGS. 4 and 5.

FIG. 4 shows the internal connections of the SMU 202 used when the system of FIG. 2A is in operation. As discussed with reference to FIG. 3, the controlled switching element 202 under the control of the microcontroller 202x determines whether AC main power is turned on or off, provided to the battery 214 and/or provided to the load 220. The solar charge controller 202p located in the internal SMU module 202e may be (as previously addressed) an MPPT charge controller, PWM charge controller and any other charge controller depending on the type specified for the SMU 202 in terms of watt peak rating of the solar panel 226.

FIG. 5 is a detailed illustration showing the internal connections of the SMU 202 when the system of FIG. 2B is implemented. The controlled switching element 202 is again under the control of the microcontroller 202x which determines whether AC main power is turned on or off, provided to the battery 214 and/or provided to the load 220. As in FIG. 4, the solar charge controller 202e receives the DC charge from the solar input terminal 202c and provides a battery charge 202h to the controlled switching element 202f and then to the battery 214 through line 212.

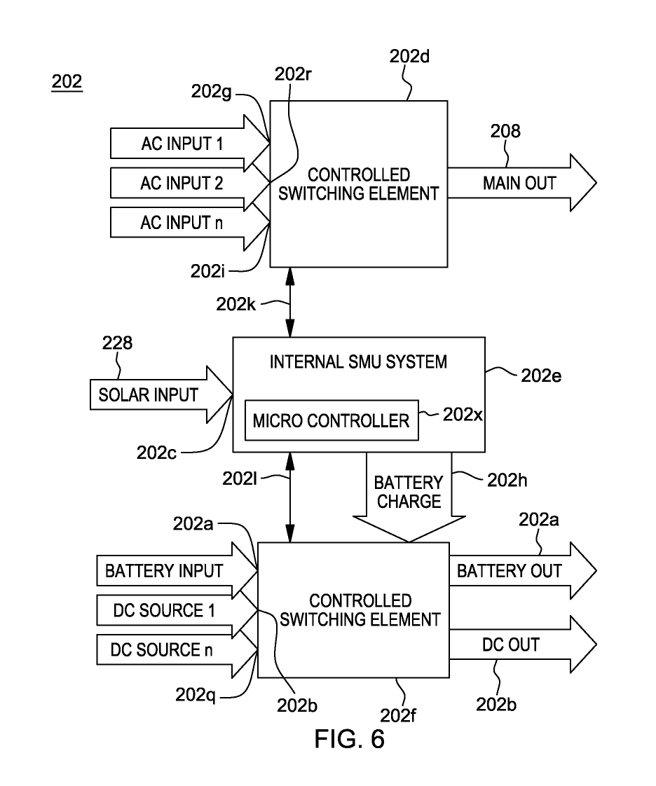

FIG. 6 represents an alternative overview block diagram of the SMU 202. The SMU 202 is scalable and capable of having multiple power sources as inputs and multiple power sources as output. The SMU 202 can be used for a plurality (“n”) of AC and/or DC input sources and can provide output as any number (“n”) of AC and/or DC outputs including multiple battery charging capabilities of different battery types. A plurality of AC inputs including AC input terminal 1 202g, AC input terminal 2 202h through AC input “n” 202i provide power from AC mains 204 and other sources to SMU 202. In addition to the battery input, 202a, controlled switching element 202f also has DC source terminal 1 (202b) and DC source terminal 2 (202q) which can provide DC power from alternative power sources such as additional solar panels, wind or diesel. Controlled switching element 202f also has DC source terminal 1 (202p) and DC source terminal 2 (202q) which can provide DC power from alternative power sources such as additional solar panels, wind or diesel. SMU 202 can also take additional sources of AC power or DC power as input and a control mechanism is provided to switch the input AC mains to other alternative AC sources. In addition, battery 214 charging can be done from the incoming power from other DC power sources and an appropriate control mechanism is provided.

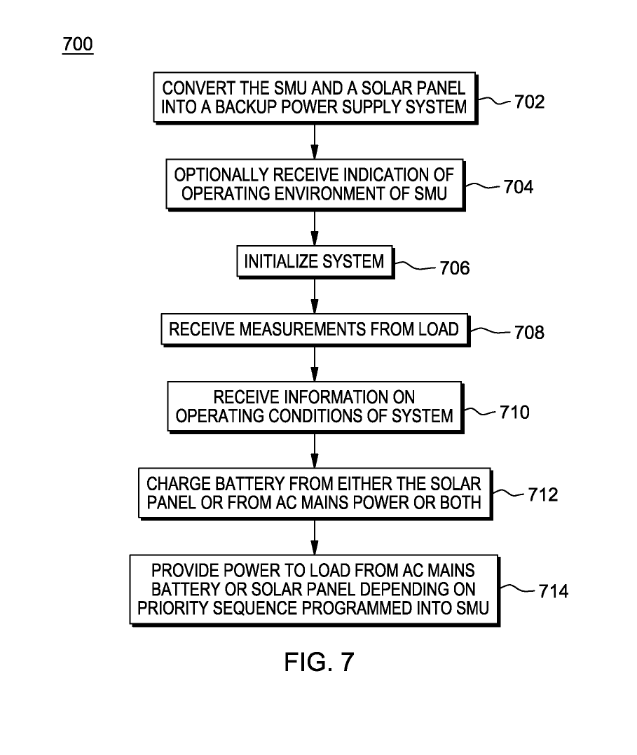

FIG. 7 illustrates a method 700 of operating a solar power system with the SMU 202 in it. In a first step, the SMU 202 is connected along with a solar panel 226 into an existing inverter based backup power supply system or UPS system. Optionally, a mode of operation (either urban or rural) is selected 704 depending on the designated environment of the solar power system. The next step is to initialize 706 the system by identifying the battery 214 capacity, inverter 210 capacity and solar panel 226 power capacity. The SMU 202 will next start to collect measurements on the load pattern from the load 220 and will do so on a continuous basis (step 708). In step 710, the SMU 202 receives information on operating conditions of the system including, but not limited to, temperature on the panel, whether the panel is receiving less than ideal sunshine due to clouds or darkness, whether the AC mains power is available, and/or whether the battery needs to be charged. In step 712, the SMU 202 will determine whether to charge the battery from the solar panel 226, from AC mains 204 or from both. In step 714 the SMU 202 will decide based on the system operating conditions of the system and the priority sequence programmed into the microcontroller 202x whether to provide power to the load 220 from AC mains 204, the battery 214 or the solar panel 226.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, devices that are in communication with or coupled with each other may communicate directly or indirectly through one or more intermediaries.

Although process (or method) steps may be described or claimed in a particular sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Moreover, the illustration of a process by its depiction in a drawing does not imply that the illustrated process is exclusive of other variations and modifications thereto, does not imply that the illustrated process or any of its steps are necessary to the embodiment(s), and does not imply that the illustrated process is preferred.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

1. A method of integrating a solar panel into a backup power supply system comprising:
connecting a solar management unit (SMU) to a pre-existing backup power system including a battery, inverter and AC mains power;
connecting at least one solar panel to the SMU;
performing an initialization process wherein the SMU detects the capacity of the battery, inverter and solar panel; and
determining which of the AC mains power or solar panel will charge the battery.

2. The method of claim 1,
wherein the SMU continuously receives measurements from a load; and
the SMU provides power to the load based on these measurements.

3. The method of claim 1,
wherein the SMU controls the power from the solar panel through an MPPT.

4. The method of claim 1, wherein the SMU provides power from the solar panel to charge the battery when the voltage of the battery falls below a predetermined level which is programmed into the SMU.

5. The method of claim 1, prioritizing which of the battery and AC mains power will provide power to a load based on a predetermined sequence contained in the SMU.

6. The method of claim 1, prioritizing which of the battery, AC mains power or solar panel will provide power to a load based on a predetermined sequence contained in the SMU.

7. The method of claim 1, further comprising:
receiving an input at the SMU indicating the environment into which the SMU will operate.

8. The method of claim 1, further comprising:
changing the connection between the battery and the inverter to a connection between the SMU and the inverter allowing the load to be driven by the solar panel.

9. The method of claim 1, further comprising:
driving the load from the solar panel when AC power fails.

10. A solar management unit (SMU) comprising:
a processor with a memory;
a plurality of terminals located on the SMU allowing the SMU to be able to receive and provide output to an inverter and at least one battery;
a solar charge controller configured to receive input from a solar panel and in communication with the processor;
a first controlled switching element in communication with the processor and directed by the processor to turn on or off AC mains power availability; and
a second controlled switching element also under control of the processor and in connection with the solar charge controller to turn on or off battery charge output.

11. The SMU of claim 10, wherein the solar charge control is an MPPT.

12. The SMU of claim 10, wherein the SMU is configured to continuously receive measurements from a load; and direct that power be provided to the load based on these measurements.

13. The SMU of claim 10, wherein the processor is configured to prioritize directing the power be provided to a load based on a predetermined sequence contained in the SMU.

14. The SMU of claim 10, wherein the processor is configured to prioritize directing that power be provided to a load based on a predetermined sequence contained in the SMU and measurement of the operating conditions of the power system.

15. The SMU of claim 10, wherein the processor is configured to direct that power be provided from the solar panel to charge the battery when a measurement is received indicating that the voltage of the battery has fallen below a predetermined level.

16. The SMU of claim 10, wherein the processor is configured to drive power to the load from AC mains.

17. The SMU of claim 10, wherein the processor is configured to drive power to the battery from either a solar panel or AC mains power depending on the measurements received of the battery voltage.

18. The SMU of claim 10, wherein the SMU is capable of directing power from a plurality of additional DC power sources including a diesel generator.

19. The SMU of claim 10, wherein the SMU is capable of receiving directions from a wireless monitoring system.

20. A solar management unit (SMU) comprising:
a processor with a memory, wherein the processor is configured to receive capacity condition measurements of a plurality of elements connected to said SMU;
a plurality of terminals located on the SMU allowing the SMU to be able to receive and provide outputs to the plurality of elements including an inverter and at least one battery;
a solar charge controller including an MPPT configured to receive input from a solar panel and in communication with the processor;
a first controlled switching element in communication with the processor and directed by the processor to turn on or off AC mains power availability;
a second controlled switching element also under control of the processor and in connection with the solar charge controller to turn on or off battery charge output; and
wherein the processor is further configured to prioritize directing that power be provided to a load based on a predetermined sequence.
